(19) United States
(12) Patent Application Publication
(10) Pub. No.: US 2013/0257649 A1
(43) Pub. Date: Oct. 3, 2013

(54) POSITIONING METHOD AND SYSTEM FOR REAL NAVIGATION AND COMPUTER READABLE STORAGE MEDIUM

(71) Applicant: Chih-Sung Chang, New Taipei City (TW)

(72) Inventor: Chih-Sung Chang, New Taipei City (TW)

(21) Appl. No.: 13/526,535

(22) Filed: Jun. 19, 2012

(30) Foreign Application Priority Data
Apr. 3, 2012 (TW) 101111827

(51) Int. Cl. G01S 19/45

(52) U.S. Cl. 342/357.28

(57) ABSTRACT

A positioning method for real navigation includes steps of receiving a satellite positioning signal; calculating a satellite positioning coordinate according to the satellite positioning signal; capturing a real scene image of a driving path; recognizing whether an indicator exists in the real scene image; if the indicator exists in the real scene image, calculating an auxiliary positioning coordinate according to the indicator; and calculating a current coordinate corresponding to the driving path according to the satellite positioning coordinate and the auxiliary positioning coordinate.

### BACKGROUND OF THE INVENTION

1. Field of the Invention

The invention relates to a positioning method and a positioning system and, more particularly, to a positioning method and a positioning system for real navigation.

2. Description of the Prior Art

As global position system (GPS) and various electronic devices (e.g. smart phone) advance and develop, vehicle navigation has been more and more improved and diversified and, especially, real navigation can be implemented in an electronic device equipped with a camera. So far the electronic device, which supports real navigation, usually uses a built-in camera to capture a real scene image and displays the captured real scene image in navigation software in real-time instead of displaying a map of a 2D or 3D map database in the navigation software. Accordingly, a user can observe a path indicated by the navigation software on the real scene image clearly through navigation information provided by the navigation software, so as to improve the recognition of the navigation information.

The present real navigation processes the real scene image and the navigation information separately. In other words, the navigation software still generate a path plan using road information of the original map database and the real scene image, which is captured by the camera, is only used to replace the map of the original map database. Then, the navigation software displays the navigation information on the real scene image to perform navigation. However, once the accuracy of GPS decreases or the navigation device cannot perform navigation function under a specific environment, the navigation information may be wrong or disappear so that the real navigation will fail.

### SUMMARY OF THE INVENTION

The invention provides a positioning method and a positioning system for real navigation and a computer readable storage medium so as to solve the aforesaid problems.

According to the claimed invention, a positioning method for real navigation comprises steps of receiving a satellite positioning signal; calculating a satellite positioning coordinate according to the satellite positioning signal; capturing a real scene image of a driving path; recognizing whether an indicator exists in the real scene image; if the indicator exists in the real scene image, calculating an auxiliary positioning coordinate according to the indicator; and calculating a current coordinate corresponding to the driving path according to the satellite positioning coordinate and the auxiliary positioning coordinate.

According to the claimed invention, the step of calculating a current coordinate corresponding to the driving path according to the satellite positioning coordinate and the auxiliary positioning coordinate further comprises steps of applying a first weighting to the satellite positioning coordinate according to a signal strength of the satellite positioning signal; applying a second weighting to the auxiliary positioning coordinate according to a recognition of the indicator; and calculating the current coordinate by weighting the satellite positioning coordinate with the first weighting and weighting the auxiliary positioning coordinate with the second weighting.

According to the claimed invention, the step of calculating the current coordinate by weighting the satellite positioning coordinate with the first weighting and weighting the auxiliary positioning coordinate with the second weighting further comprises step of calculating the current coordinate (Xc,Yc) by an equation as follows,

$$( Xc , Yc ) = \frac{( X 1 , Y 1 ) \times W 1 + ( X 2 , Y 2 ) \times W 2}{W 1 + W 2} ;$$

wherein (X1,Y1) represents the satellite positioning coordinate, (X2,Y2) represents the auxiliary positioning coordinate, W1 represents the first weighting, and W2 represents the second weighting.

According to the claimed invention, the indicator is a milepost indicator, the step of calculating an auxiliary positioning coordinate according to the indicator further comprises step of calculating the auxiliary positioning coordinate according to a position of the milepost indicator in a map database.

According to the claimed invention, the indicator is an object-type indicator, the step of calculating an auxiliary positioning coordinate according to the indicator further comprises steps of comparing the object-type indicator with at least one scenic spot of the driving path in a map database; selecting a scenic spot, which conforms to the object-type indicator, from the at least one scenic spot; and calculating the auxiliary positioning coordinate according to a position of the selected scenic spot in the map database.

According to the claimed invention, a positioning system for real navigation comprises a signal receiving unit for receiving a satellite positioning signal; an image capturing unit for capturing a real scene image of a driving path; and a processing unit electrically connected to the signal receiving unit and the image capturing unit, the processing unit calculating a satellite positioning coordinate according to the satellite positioning signal and recognizing whether an indicator exists in the real scene image, if the indicator exists in the real scene image, the processing unit calculating an auxiliary positioning coordinate according to the indicator and calculating a current coordinate corresponding to the driving path according to the satellite positioning coordinate and the auxiliary positioning coordinate.

According to the claimed invention, the processing unit applies a first weighting to the satellite positioning coordinate according to a signal strength of the satellite positioning signal, applies a second weighting to the auxiliary positioning coordinate according to a recognition of the indicator, and calculates the current coordinate by weighting the satellite positioning coordinate with the first weighting and weighting the auxiliary positioning coordinate with the second weighting.

According to the claimed invention, the processing unit calculates the current coordinate (Xc,Yc) by an equation as follows,

$$( Xc , Yc ) = \frac{( X 1 , Y 1 ) \times W 1 + ( X 2 , Y 2 ) \times W 2}{W 1 + W 2} ;$$

wherein (X1,Y1) represents the satellite positioning coordinate, (X2,Y2) represents the auxiliary positioning coordinate, W1 represents the first weighting, and W2 represents the second weighting.

According to the claimed invention, the positioning system further comprises a storage unit electrically connected to the processing unit and used for storing a map database, wherein the indicator is a milepost indicator and the processing unit calculates the auxiliary positioning coordinate according to a position of the milepost indicator in the map database.

According to the claimed invention, the positioning system further comprises a storage unit electrically connected to the processing unit and used for storing a map database, wherein the indicator is an object-type indicator and the processing unit compares the object-type indicator with at least one scenic spot of the driving path in the map database, selects a scenic spot, which conforms to the object-type indicator, from the at least one scenic spot, and calculates the auxiliary positioning coordinate according to a position of the selected scenic spot in the map database.

According to the claimed invention, a computer readable storage medium is used for storing a set of instructions, the set of instructions executes steps of after receiving a satellite positioning signal, calculating a satellite positioning coordinate according to the satellite positioning signal; after capturing a real scene image of a driving path, recognizing whether an indicator exists in the real scene image; if the indicator exists in the real scene image, calculating an auxiliary positioning coordinate according to the indicator; and calculating a current coordinate corresponding to the driving path according to the satellite positioning coordinate and the auxiliary positioning coordinate.

According to the claimed invention, the set of instructions executes steps of applying a first weighting to the satellite positioning coordinate according to a signal strength of the satellite positioning signal; applying a second weighting to the auxiliary positioning coordinate according to a recognition of the indicator; and calculating the current coordinate by weighting the satellite positioning coordinate with the first weighting and weighting the auxiliary positioning coordinate with the second weighting.

According to the claimed invention, the set of instructions executes step of calculating the current coordinate (Xc,Yc) by an equation as follows,

$$( Xc , Yc ) = \frac{( X 1 , Y 1 ) \times W 1 + ( X 2 , Y 2 ) \times W 2}{W 1 + W 2} ;$$

wherein (X1,Y1) represents the satellite positioning coordinate, (X2,Y2) represents the auxiliary positioning coordinate, W1 represents the first weighting, and W2 represents the second weighting.

According to the claimed invention, the indicator is a milepost indicator, the set of instructions executes step of calculating the auxiliary positioning coordinate according to a position of the milepost indicator in a map database.

According to the claimed invention, the indicator is an object-type indicator, the set of instructions executes steps of comparing the object-type indicator with at least one scenic spot of the driving path in a map database; selecting a scenic spot, which conforms to the object-type indicator, from the at least one scenic spot; and calculating the auxiliary positioning coordinate according to a position of the selected scenic spot in the map database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a positioning system for real navigation according to an embodiment of the invention.

FIG. 2 is a schematic diagram illustrating the positioning system shown in FIG. 1 being installed in a vehicle.

FIG. 3 is a flowchart illustrating a positioning method for real navigation according to an embodiment of the invention.

FIG. 4 is a flowchart illustrating step S110 shown in FIG. 3 in detail.

FIG. 5 is a schematic diagram illustrating an indicator in the real scene image captured by the image capturing unit shown in FIG. 1.

FIG. 6 is a schematic diagram illustrating another indicator in the real scene image captured by the image capturing unit shown in FIG. 1.

### DETAILED DESCRIPTION

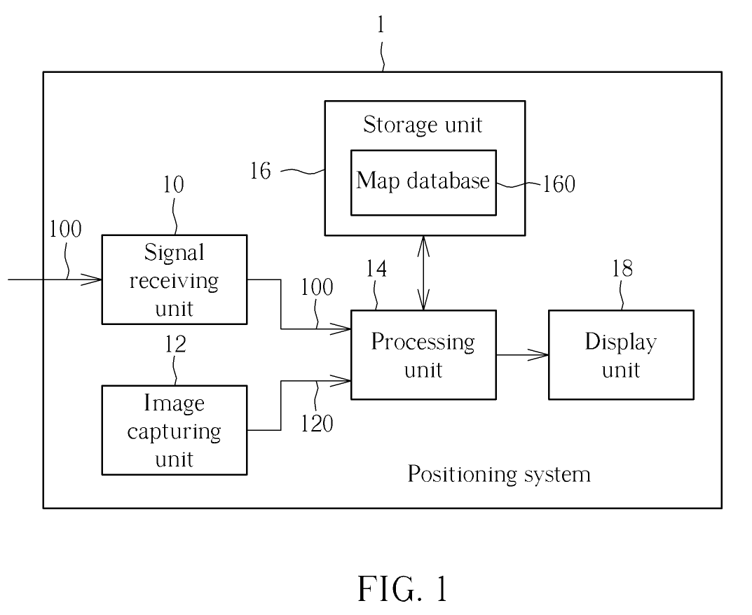

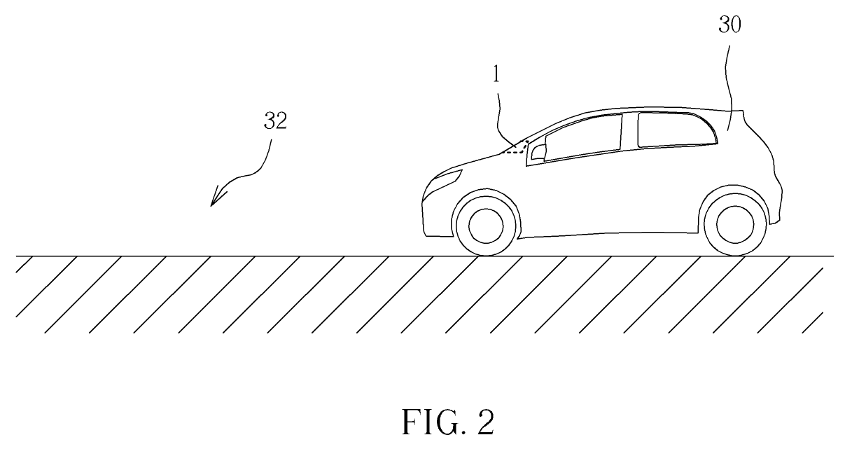

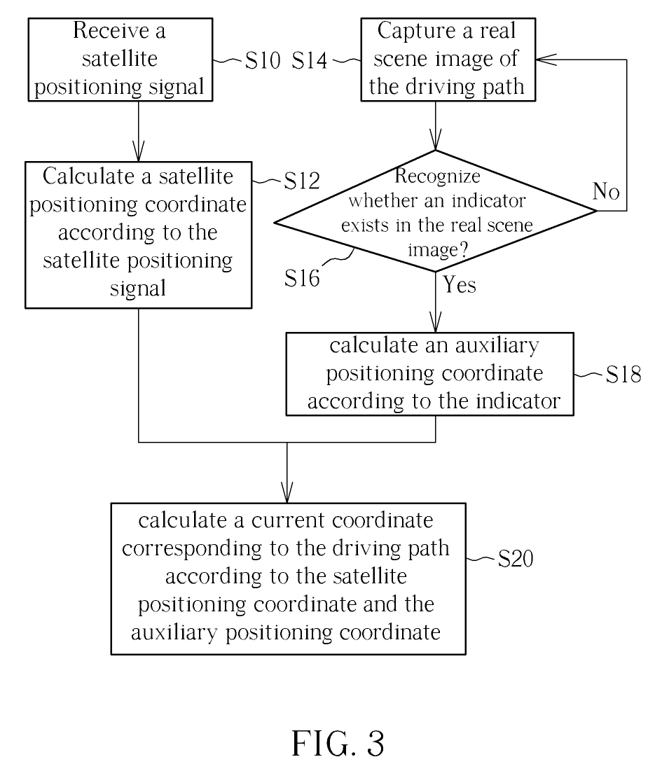

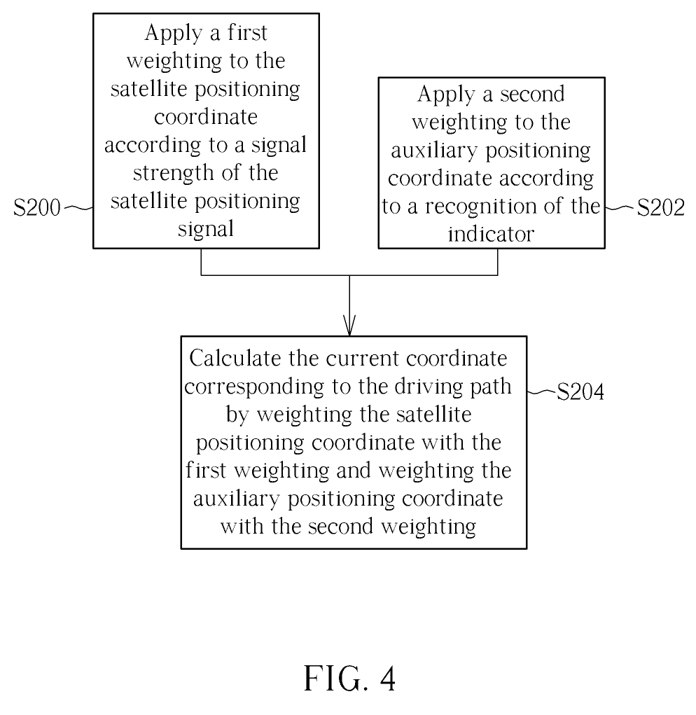

Referring to FIGS. 1 to 4, FIG. 1 is a functional block diagram illustrating a positioning system 1 for real navigation according to an embodiment of the invention, FIG. 2 is a schematic diagram illustrating the positioning system 1 shown in FIG. 1 being installed in a vehicle 30, FIG. 3 is a flowchart illustrating a positioning method for real navigation according to an embodiment of the invention, and FIG. 4 is a flowchart illustrating step S110 shown in FIG. 3 in detail, wherein the positioning method shown in FIG. 3 can be implemented by the positioning system 1 shown in FIG. 1.

As shown in FIG. 1, the positioning system 1 comprises a signal receiving unit 10, an image capturing unit 12, a processing unit 14, a storage unit 16 and a display unit 18, wherein the processing unit 14 is electrically connected to the signal receiving unit 10, the image capturing unit 12, the storage unit 16 and the display unit 18. In practical applications, the positioning system 1 may be a smart phone, a navigation device or other electronic devices with satellite positioning function and image capturing function; the signal receiving unit 10 may be a GPS module or other satellite positioning modules; the image capturing unit 12 may be a charge-coupled device (CCD) sensor, a complementary metal-oxide semiconductor (CMOS) sensor or other image sensors; the processing unit 14 may be a processor or a controller with data calculating/processing functions; the storage unit 16 may be a hard disc, a memory or other devices capable of storing data; and the display unit 18 may be a liquid crystal display (LCD) device or other display devices. In general, the positioning system 1 may be equipped with some necessary hardware or software components for specific purposes, such as a power supply, an operating system, an antenna, etc., and it depends on practical applications.

The storage unit 16 is used for storing a map database 160. The signal receiving unit 10 is used for receiving a satellite positioning signal 100 (step S10 shown in FIG. 3) and transmitting the satellite positioning signal 100 to the processing unit 14 such that the processing unit 14 calculates a satellite positioning coordinate according to the satellite positioning signal 100 (step S12 shown in FIG. 3). As shown in FIGS. 1 and 2, when a vehicle 30 moves forward along a driving path 32 and a navigation software for implementing the positioning method of the invention has been executed, the image capturing unit 12 captures a real scene image 120 of the driving path 32 (step S14 shown in FIG. 3) and transmits the real scene image 120 to the processing unit 14. After receiving the real scene image 120, the processing unit 14 recognizes whether an indicator exists in the real scene image 120 (step S16 shown in FIG. 3). If the indicator exists in the real scene image 120, the processing unit 14 calculates an auxiliary positioning coordinate according to the indicator (step S18 shown in FIG. 3). Afterward, the processing unit 14 calculates a current coordinate corresponding to the driving path 32 according to the satellite positioning coordinate and the auxiliary positioning coordinate (step S20 shown in FIG. 3). The current coordinate indicates a current position of the vehicle 30 on the driving path 32. On the other hand, if there is no any indicator in the real scene image 120, step S14 is performed again.

In this embodiment, the processing unit 14 may apply a first weighting to the satellite positioning coordinate according to a signal strength of the satellite positioning signal 100 (step S200 shown in FIG. 4) and apply a second weighting to the auxiliary positioning coordinate according to a recognition of the indicator (step S202 shown in FIG. 4). Afterward, the processing unit 14 calculates the current coordinate corresponding to the driving path 32 by weighting the satellite positioning coordinate with the first weighting and weighting the auxiliary positioning coordinate with the second weighting (step S204 shown in FIG. 4). In this embodiment, the processing unit 14 may calculate the current coordinate (Xc,Yc) by an equation 1 as follows, wherein (X1,Y1) represents the satellite positioning coordinate, (X2,Y2) represents the auxiliary positioning coordinate, W1 represents the first weighting, and W2 represents the second weighting.

$$( Xc , Yc ) = \frac{( X 1 , Y 1 ) \times W 1 + ( X 2 , Y 2 ) \times W 2}{W 1 + W 2} . \qquad Equation 1$$

In this embodiment, the relation between the signal strength of the satellite positioning signal 100 and the first weighting is shown in the following table 1 for example and the relation between the recognition of the indicator and the second weighting is shown in the following table 2 for example. It should be noted that the tables 1 and 2 are one embodiment used for implementing the invention. The relation between the signal strength of the satellite positioning signal 100 and the first weighting and the relation between the recognition of the indicator and the second weighting may be set in different manners according to practical applications. In other words, the invention is not limited to the relations set in the tables 1 and 2.

TABLE 1

| Signal strength of satellite | |
|---|---|
| positioning signal | First weighting |
| 91%~100% | 10 |
| 81%~90% | 9 |
| 71%~80% | 8 |
| 61%~70% | 7 |
| 51%~60% | 6 |
| 41%~50% | 5 |
| 31%~40% | 4 |
| 21%~30% | 3 |
| 11%~20% | 2 |
| 1%~10% | 1 |
| 0% | 0 |

TABLE 2

| Recognition of indicator | Second weighting |
|---|---|
| 91%~100% | 10 |
| 81%~90% | 9 |
| 71%~80% | 8 |
| 61%~70% | 7 |
| 51%~60% | 6 |
| 41%~50% | 5 |
| 31%~40% | 4 |
| 21%~30% | 3 |
| 11%~20% | 2 |
| 1%~10% | 1 |
| 0% | 0 |

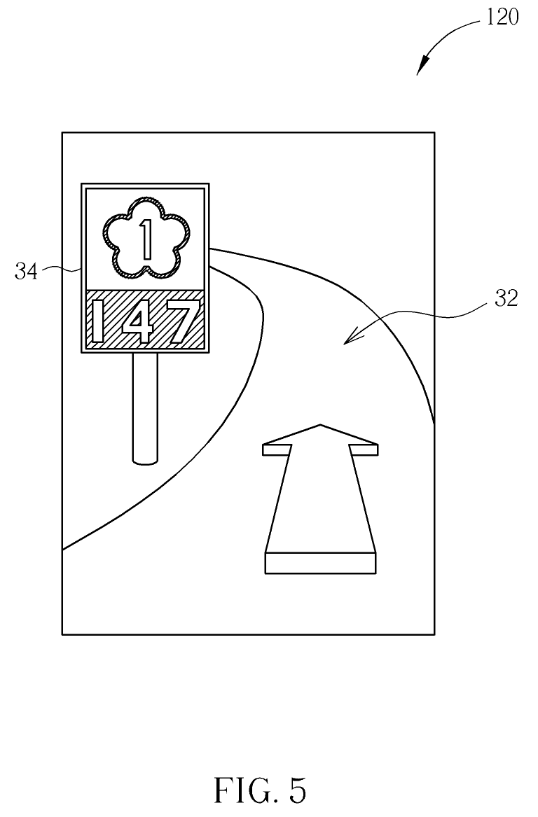

Referring to FIG. 5, FIG. 5 is a schematic diagram illustrating an indicator 34 in the real scene image 120 captured by the image capturing unit 12 shown in FIG. 1. As shown in FIG. 5, the indicator 34 is a milepost indicator, wherein the milepost indicator 34 shows a road type and a mileage. When the processing unit 14 recognizes that the milepost indicator 34 exists in the real scene image 120, the processing unit 14 calculates the aforesaid auxiliary positioning coordinate according to a position of the milepost indicator 34 in the map database 160. Afterward, the processing unit 14 applies the second weighting to the auxiliary positioning coordinate according to the recognition of the milepost indicator 34 and puts the auxiliary positioning coordinate and the second weighting into the aforesaid equation 1 to calculate the current coordinate. The recognition of the milepost indicator 34 may comprise, but not limited to, a recognizable level of the milepost indicator 34 recognized by the processing unit 14 from the real scene image 120 and a recognizable level of the position of the milepost indicator 34 recognized by the processing unit 14 from the map database 160.

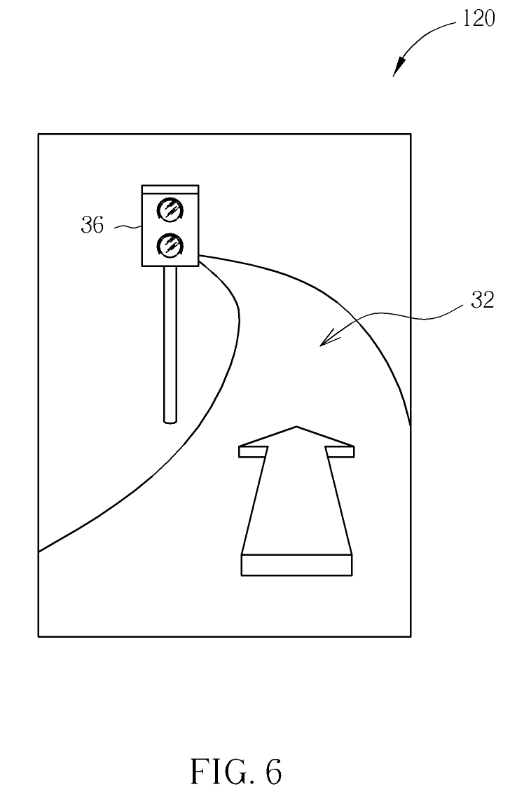

Referring to FIG. 6, FIG. 6 is a schematic diagram illustrating another indicator 36 in the real scene image 120 captured by the image capturing unit 12 shown in FIG. 1. As shown in FIG. 6, the indicator 36 is an object-type indicator, wherein the object-type indicator 36 is, but not limited to, a speed camera. The object-type indicator 36 may be any scenic spots, which may appear on the driving path 32, including a speed camera, a gas station, a convenience store, a street marker, an overpass and so on. When the processing unit 14 recognizes that the object-type indicator 36 exists in the real scene image 120, the processing unit 14 compares the object-type indicator 36 with at least one scenic spot (e.g. speed camera, gas station, convenience store, street marker, overpass and so on) of the driving path 32 in the map database 160 and selects a scenic spot, which conforms to the object-type indicator 36, from the at least one scenic spot. Afterward, the processing unit 14 calculates the aforesaid auxiliary positioning coordinate according to a position of the selected scenic spot in the map database 160 (i.e. a position of the object-type indicator 36 in the map database 160). Afterward, the processing unit 14 applies the second weighting to the auxiliary positioning coordinate according to the recognition of the object-type indicator 36 and puts the auxiliary positioning coordinate and the second weighting into the aforesaid equation 1 to calculate the current coordinate. The recognition of the object-type indicator 36 may comprise, but not limited to, a recognizable level of the object-type indicator 36 recognized by the processing unit 14 from the real scene image 120 and a recognizable level of the position of the object-type indicator 36 recognized by the processing unit 14 from the map database 160.

It should be noted that there may be more than one object-type indicator 36 existing in the real scene image 120. If the processing unit 14 can recognize all object-type indicators 36 from the real scene image 120 and find out all positions of the object-type indicators 36 from the map database 160, the accuracy of the auxiliary positioning coordinate will be higher and the second weighting of the auxiliary positioning coordinate will be larger so that the accuracy of the current coordinate will be enhanced correspondingly.

Furthermore, if the milepost indicator 34 and the object-type indicator 36 exist in the real scene image 120 simultaneously and the processing unit 14 can recognize the milepost indicator 34 and the object-type indicator 36 from the real scene image 120, the processing unit 14 may calculate the auxiliary positioning coordinate by the milepost indicator 34 mainly since the recognition of the milepost indicator 34 is usually higher than the recognition of the object-type indicator 36. However, if the recognition of the object-type indicator 36 is higher than the recognition of the milepost indicator 34, the processing unit 14 may also calculate the auxiliary positioning coordinate by the object-type indicator 36 mainly. As a matter of course, the processing unit 14 may also calculate the auxiliary positioning coordinate by the milepost indicator 34 and the object-type indicator 36 simultaneously.

After the image capturing unit 12 captures the real scene image 120 of the driving path 32, the processing unit 14 displays the real scene image 120 on the display unit 18 in real-time and modifies navigation information by the current coordinate calculated by the aforesaid positioning method. Accordingly, the invention can use the real scene image 120, which is captured by the image capturing unit 12, to assist in providing positioning coordinate so as to improve the accuracy of navigation information and the efficiency of real navigation.

Furthermore, the control logic of the positioning method shown in FIGS. 3 and 4 can be implemented by software. The software can be executed in any electronic devices with data processing function, such as smart phone, navigation device or other electronic devices with satellite positioning function and image capturing function. Needless to say, each part or function of the control logic may be implemented by software, hardware or the combination thereof. Moreover, the control logic of the positioning method shown in FIGS. 3 and 4 can be embodied by a computer readable storage medium, wherein the computer readable storage medium stores instructions, which can be executed by an electronic device so as to generate control command for executing corresponding function.

As mentioned in the above, when the processing unit recognizes that an indicator exists in the real scene image captured by the image capturing unit, the processing unit will calculate the auxiliary positioning coordinate according to the indicator and calculate the current coordinate corresponding to the driving path according to the satellite positioning coordinate and the auxiliary positioning coordinate. In other words, the invention obtains the auxiliary positioning coordinate from the real scene image and combines the auxiliary positioning coordinate with the satellite positioning coordinate so as to integrate real scene with navigation. Accordingly, the invention can use the real scene image to assist in providing positioning coordinate. Therefore, once the accuracy of satellite positioning signal decreases or the navigation device cannot receive satellite positioning signal under a specific environment, the invention can use the real scene image, which is captured by the image capturing unit, to assist in providing positioning coordinate so as to improve the accuracy of navigation information and the efficiency of real navigation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A positioning method for real navigation comprising:
receiving a satellite positioning signal;
calculating a satellite positioning coordinate according to the satellite positioning signal;
capturing a real scene image of a driving path;
recognizing whether an indicator exists in the real scene image;
if the indicator exists in the real scene image, calculating an auxiliary positioning coordinate according to the indicator; and
calculating a current coordinate corresponding to the driving path according to the satellite positioning coordinate and the auxiliary positioning coordinate.

2. The positioning method of claim 1, wherein calculating a current coordinate corresponding to the driving path according to the satellite positioning coordinate and the auxiliary positioning coordinate further comprises:
applying a first weighting to the satellite positioning coordinate according to a signal strength of the satellite positioning signal;
applying a second weighting to the auxiliary positioning coordinate according to a recognition of the indicator; and
calculating the current coordinate by weighting the satellite positioning coordinate with the first weighting and weighting the auxiliary positioning coordinate with the second weighting.

3. The positioning method of claim 2, wherein calculating the current coordinate by weighting the satellite positioning coordinate with the first weighting and weighting the auxiliary positioning coordinate with the second weighting further comprises:
calculating the current coordinate (Xc,Yc) by an equation as follows,
$$( Xc , Yc ) = \frac{( X 1 , Y 1 ) \times W 1 + ( X 2 , Y 2 ) \times W 2}{W 1 + W 2} ;$$
wherein (X1,Y1) represents the satellite positioning coordinate, (X2,Y2) represents the auxiliary positioning coordinate, W1 represents the first weighting, and W2 represents the second weighting.

4. The positioning method of claim 1, wherein the indicator is a milepost indicator, calculating an auxiliary positioning coordinate according to the indicator further comprises:
calculating the auxiliary positioning coordinate according to a position of the milepost indicator in a map database.

5. The positioning method of claim 1, wherein the indicator is an object-type indicator, calculating an auxiliary positioning coordinate according to the indicator further comprises:
comparing the object-type indicator with at least one scenic spot of the driving path in a map database;
selecting a scenic spot, which conforms to the object-type indicator, from the at least one scenic spot; and
calculating the auxiliary positioning coordinate according to a position of the selected scenic spot in the map database.

6. A positioning system for real navigation comprising:
a signal receiving unit for receiving a satellite positioning signal;
an image capturing unit for capturing a real scene image of a driving path; and
a processing unit electrically connected to the signal receiving unit and the image capturing unit, the processing unit calculating a satellite positioning coordinate according to the satellite positioning signal and recognizing whether an indicator exists in the real scene image, if the indicator exists in the real scene image, the processing unit calculating an auxiliary positioning coordinate according to the indicator and calculating a current coordinate corresponding to the driving path according to the satellite positioning coordinate and the auxiliary positioning coordinate.

7. The positioning system of claim 6, wherein the processing unit applies a first weighting to the satellite positioning coordinate according to a signal strength of the satellite positioning signal, applies a second weighting to the auxiliary positioning coordinate according to a recognition of the indicator, and calculates the current coordinate by weighting the satellite positioning coordinate with the first weighting and weighting the auxiliary positioning coordinate with the second weighting.

8. The positioning system of claim 7, wherein the processing unit calculates the current coordinate (Xc,Yc) by an equation as follows,
$$( Xc , Yc ) = \frac{( X 1 , Y 1 ) \times W 1 + ( X 2 , Y 2 ) \times W 2}{W 1 + W 2} ;$$
wherein (X1,Y1) represents the satellite positioning coordinate, (X2,Y2) represents the auxiliary positioning coordinate, W1 represents the first weighting, and W2 represents the second weighting.

9. The positioning system of claim 6, further comprising a storage unit electrically connected to the processing unit and used for storing a map database, wherein the indicator is a milepost indicator and the processing unit calculates the auxiliary positioning coordinate according to a position of the milepost indicator in the map database.

10. The positioning system of claim 6, further comprising a storage unit electrically connected to the processing unit and used for storing a map database, wherein the indicator is an object-type indicator and the processing unit compares the object-type indicator with at least one scenic spot of the driving path in the map database, selects a scenic spot, which conforms to the object-type indicator, from the at least one scenic spot, and calculates the auxiliary positioning coordinate according to a position of the selected scenic spot in the map database.

11. A computer readable storage medium for storing a set of instructions, the set of instructions executing steps of:
after receiving a satellite positioning signal, calculating a satellite positioning coordinate according to the satellite positioning signal;
after capturing a real scene image of a driving path, recognizing whether an indicator exists in the real scene image;
if the indicator exists in the real scene image, calculating an auxiliary positioning coordinate according to the indicator; and
calculating a current coordinate corresponding to the driving path according to the satellite positioning coordinate and the auxiliary positioning coordinate.

12. The computer readable storage medium of claim 11, the set of instructions executing steps of:
applying a first weighting to the satellite positioning coordinate according to a signal strength of the satellite positioning signal;
applying a second weighting to the auxiliary positioning coordinate according to a recognition of the indicator; and
calculating the current coordinate by weighting the satellite positioning coordinate with the first weighting and weighting the auxiliary positioning coordinate with the second weighting.

13. The computer readable storage medium of claim 12, the set of instructions executing step of:
calculating the current coordinate (Xc,Yc) by an equation as follows,
$$( Xc , Yc ) = \frac{( X 1 , Y 1 ) \times W 1 + ( X 2 , Y 2 ) \times W 2}{W 1 + W 2} ;$$
wherein (X1,Y1) represents the satellite positioning coordinate, (X2,Y2) represents the auxiliary positioning coordinate, W1 represents the first weighting, and W2 represents the second weighting.

14. The computer readable storage medium of claim 11, wherein the indicator is a milepost indicator, the set of instructions executes step of:
calculating the auxiliary positioning coordinate according to a position of the milepost indicator in a map database.

15. The computer readable storage medium of claim 11, wherein the indicator is an object-type indicator, the set of instructions executes steps of:
comparing the object-type indicator with at least one scenic spot of the driving path in a map database;
selecting a scenic spot, which conforms to the object-type indicator, from the at least one scenic spot; and
calculating the auxiliary positioning coordinate according to a position of the selected scenic spot in the map database.
